(19) United States
(12) Patent Application Publication
(10) Pub. No.: US 2020/0253002 A1
(43) Pub. Date: Aug. 6, 2020

(54) INDUCTION HOB COMPRISING AN ELECTROMAGNETIC INTERFERENCE FILTER

(71) Applicant: ELECTROLUX APPLIANCES AKTIEBOLAG, Stockholm (SE)

(72) Inventors: Alex VIROLI, Forli (IT); Simone SANTILANO, Forli (IT); Laurent JEANNETEAU, Compiegne (FR); Massimo ZANGOLI, Forli (IT); Filippo MILANESI, Forli (IT); Emanuel URGESE, Forli (IT)

(21) Appl. No.: 16/652,163

(22) PCT Filed: Oct. 8, 2018
(86) PCT No.: PCT/EP2018/077280

§ 371 Date: Mar. 30, 2020

(30) Foreign Application Priority Data
Oct. 25, 2017 (EP) 17198393.5

(51) Int. Cl. H05B 6/04; H02M 1/44; H01F 27/24; H01F 27/28

(52) U.S. Cl. CPC H05B 6/04; H01F 27/28; H01F 27/24; H02M 1/44

(57) ABSTRACT

Induction hob comprising an AC power input (2) and a power conversion entity (3) adapted to provide high frequency electric current to an induction coil, wherein an electromagnetic filtering section (1) is provided between said AC power input (2) and said power conversion entity (3), said electromagnetic filtering section (1) comprising common mode filtering means and differential mode filtering means, wherein said electromagnetic filtering section (1) comprises a closed magnetic core element (4) around which at least two coils (5, 6) are provided, said closed magnetic core element (4) and said coils (5, 6) providing said common mode filtering means, and wherein said differential mode filtering means are adapted to enable a direct magnetic flux between the coil ends (5.1, 5.2, 6.1, 6.2) of each coil (5, 6) in order to obtain differential mode filtering effect.

Generally, the present invention relates to the field of induction hobs. More specifically, the present invention relates to an induction hob comprising an electromagnetic interference filter for filtering interferences occurring in the power unit of the induction hob.

### BACKGROUND OF THE INVENTION

Induction hobs for preparing food are well known in prior art. Induction hobs typically comprise at least one heating zone which is associated with at least one induction coil. For heating a piece of cookware placed on the heating zone, the induction coil is coupled with electronic driving means, in the following referred to as power unit, for driving an AC current through the induction coil. Said power unit may include an AC power input and a power conversion entity providing high frequency electric current to the induction coil.

Disadvantageously, within said power unit high-frequency noise is generated. Said high-frequency noise has detrimental effect, for example on the AC mains voltage. Therefore, an electromagnetic interference filter is used for reducing the effect of high-frequency noise. Said electromagnetic interference filter may comprise a plurality of electrical components in order to implement common mode and differential mode filtering capabilities.

### SUMMARY OF THE INVENTION

It is an objective of the embodiments of the present invention to provide an induction hob including an electromagnetic interference filter with reduced filter complexity. The objective is solved by the features of the independent claims. Preferred embodiments are given in the dependent claims. If not explicitly indicated otherwise, embodiments of the invention and single features of said embodiments can be freely combined with each other.

According to an aspect, the invention relates to an induction hob comprising an AC power input (i.e. mains voltage input) and a power conversion entity adapted to provide high frequency electric current to an induction coil. An electromagnetic filtering section is provided between said AC power input and said power conversion entity. Preferably, said electromagnetic filtering section comprises common mode filtering means and differential mode filtering means. Said electromagnetic filtering section may particularly comprise a closed magnetic core element around which at least two coils are provided. Said closed magnetic core element and said coils preferably provide said common mode filtering means. Said differential mode filtering means more preferably are adapted to enable a direct magnetic flux between the coil ends of each coil in order to obtain differential mode filtering effect.

Said induction hob is advantageous because said electromagnetic filtering section provides common mode and differential mode filtering capabilities in a single component. Thereby, the installation space of the filtering section and manufacturing costs can be reduced.

According to embodiments, said closed magnetic core element comprises a ring-like or polygonal shape. Said closed magnetic core element may be built by a single core element or may comprise multiple core element sections which are assembled such that a closed magnetic core element is built.

According to embodiments, said differential mode filtering means comprise a bar-shaped or plate-shaped core element arranged between said coils. Based on said bar-shaped or plate-shaped core element, a shortcut for the magnetic flux is created, said short cut being arranged between the electromagnetic coils. Said bar-shaped or plate-shaped core element adds differential mode filtering capabilities to a common mode filter formed by the closed magnetic core element and the pair of coils.

According to embodiments, an air gap is provided at one side or at each side between said bar-shaped or plate-shaped core element and said closed magnetic core element. Thereby, the filtering behaviour of the filtering section can be designed according the required needs. Specifically, the relationship between common mode and differential mode filtering capabilities can be tuned by including one or two air gaps, respectively, by selecting the width of the air gap.

According to embodiments, said closed magnetic core element comprises core projections facing each other at opposite sections of the closed magnetic core element, said core projections forming said means for closing a magnetic flux between said coils. So, in other words, said core projections partially reduce a gap between core element sections which extend between the coil ends of said two coils. Said core projections may be integrally formed at the closed magnetic core element. Preferably, a single air gap is provided in a central region between said two coils and between said core projections.

According to embodiments, the sections of the closed magnetic core element arranged between said coils comprise an E-like or essentially E-like shape. For example, the upper and lower leg of an E-shaped magnetic core element section extends into an inner portion of said coils and the central leg forms the core projection which extends into a central portion arranged between said coils.

m According to embodiments, said closed magnetic core element and/or said bar-shaped or plate-shaped core element are injection moulded or powder compression moulded elements.

According to embodiments, said closed magnetic core element and/or said bar-shaped or plate-shaped core element are made of ferrite or laminated metal sheet.

According to embodiments, said coils comprise the same number of windings. Preferably, said coils comprise the same winding direction. Thereby, a symmetric filtering effect is obtained.

According to other embodiments, said coils comprise a different number of turns. Thereby, the differential filtering effect is enhanced.

According to embodiments, the permeability of said closed magnetic core element and/or said bar-shaped or plate-shaped core element is chosen in order to achieve a desired filtering effect. Thereby, desired filtering capabilities for induction hob applications can be obtained.

According to a further aspect, a method for increasing differential filtering effect in an induction hob is provided. Said induction hob comprises an AC power input and a power conversion entity adapted to provide high frequency electric current to an induction coil. Said induction hob further comprises an electromagnetic filtering section provided between said AC power input and said power conversion entity. Said electromagnetic filtering section comprises common mode filtering means and differential mode filtering means. Said electromagnetic filtering section comprises a closed magnetic core element around which at least two coils are provided. Said closed magnetic core element and said coils provide said common mode filtering. Said differential mode filtering means enable a direct magnetic flux between the coil ends of each coil in order to obtain differential mode filtering effect.

The terms “essentially”, “substantially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows a schematic circuit diagram of a power unit of an induction hob;

FIG. 2 shows an electromagnetic filtering section comprising common mode and differential mode filtering capabilities based on an additional core section provided between the coils;

FIG. 3 illustrates the cancelling of magnetic flux in a choke comprising a pair of coils and a ring-shaped core element;

FIG. 4 illustrates differential mode filtering capabilities of a choke additionally comprising a bar-shaped core element;

FIG. 5 shows an embodiment of a choke with a bar-shaped core element which is distanced from the ring-shaped core element by means of air gaps; and

FIG. 6 shows a further embodiment of an electromagnetic filtering section comprising core projections between the coils which are spaced by a central air gap.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

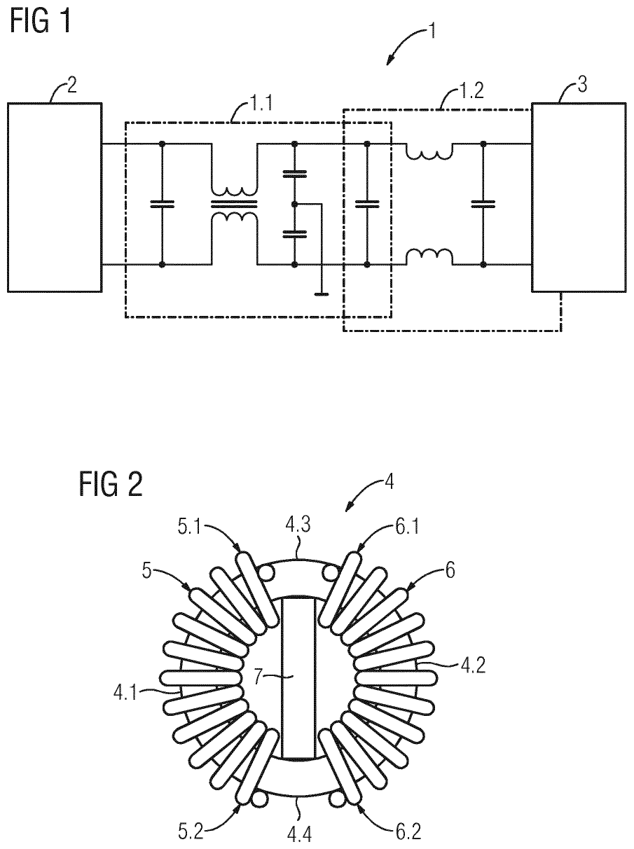

FIG. 1 illustrates a schematic equivalent circuit diagram of a power unit circuitry included in an induction hob.

The circuitry comprises an AC power input 2, a power conversion entity 3 and an electromagnetic filter section 1 included between said AC power input 2 and said power conversion entity 3. Said AC power input 2 provides AC mains power to the power conversion entity 3 in order to enable a provision of electric power to an induction coil coupled with the power conversion entity 3. Said power conversion entity 3 may provide electronic driving means for driving an AC current through the induction coil. For example, the power conversion entity 3 may comprise a switching section including one or more switching elements (e.g. IGBTs) and a resonant section which is put into oscillation by means of the switching section.

In order to avoid or suppress interference between the AC power input 2 and the power conversion entity 3, said electromagnetic filter section 1 provide electrical filtering capabilities. Specifically, said electromagnetic filter section 1 is adapted to suppress high frequency interferences generated in the power conversion entity 3 and having a detrimental effect on the AC power input 2.

In order to face with common mode and differential mode interferences, the electromagnetic filter section 1 comprises common mode filtering means and differential mode filtering means.

In state of the art electromagnetic filter sections included in induction hobs, the common mode and differential mode filtering means are provided by different filtering sections, namely a common mode filtering section 1.1 and a differential mode filtering section 1.2, which are highlighted in the schematic equivalent circuit of FIG. 1 by dashed frames. In addition, said common mode filtering section 1.1 and said differential mode filtering section 1.2 may comprise different electronic elements for realizing said filtering sections 1.1, 1.2.

FIG. 2 shows an embodiment of an electromagnetic filter section 1 which combines common mode and differential mode filtering capabilities in a single electronic device. The electromagnetic filter section 1 comprises a choke which includes common mode and differential mode filtering means.

More in detail, the choke comprises a closed magnetic core element 4 and a pair of coils 5, 6 arranged at said closed magnetic core element 4. More in detail, the closed magnetic core element 4 comprises a first and a second coil section 4.1, 4.2, at which said coils 5, 6 are provided. Specifically, the windings of the coil 5 are wound around said first coil section 4.1 and the windings of the coil 6 are wound around said second coil section 4.2. Said first and second coil sections 4.1, 4.2 may be arranged opposite to each other.

In addition, said closed magnetic core element 4 comprises a pair of coupling sections 4.3, 4.4, said coupling sections 4.3, 4.4 coupling the first and second coil sections 4.1, 4.2 at opposite sides. More in detail, the coupling section 4.3 may be arranged between the free ends 5.1, 6.1 of the coils 5, 6 and the coupling section 4.4 may be arranged between the free ends 5.2, 6.2 of the coils 5, 6. Thereby a closed magnetic core element 4 is provided.

Said closed magnetic core element 4 may comprise a ring-like, circular or polygonal, specifically rectangular or quadratic shape.

The closed magnetic core element 4 comprising the pair of coils 5, 6 for enabling an electrical coupling between the AC power input 2 and the power conversion entity 3 acts as a common mode filtering choke because electric noise signals flowing in the same direction cause a high impedance within the choke and are therefore suppressed.

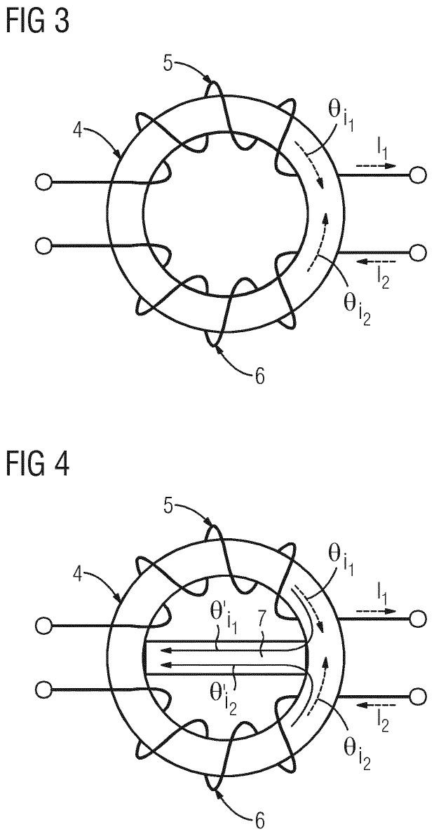

However, a common mode filtering choke does not comprise differential filtering capabilities because, as shown in FIG. 3, magnetic flux caused by differential mode currents (I₁, I₂) cancels each other and therefore the impedance for differential mode currents is low.

In order to enhance the differential mode filtering capabilities, the choke comprises a plate-shaped or bar-shaped core element 7 (cf. FIG. 1). Said plate-shaped or bar-shaped core element 7 may be arranged symmetrically between said coils 5, 6. The core element 7 may provide a magnetic flux between the coupling sections 4.3, 4.4. According to an embodiment, the free ends of the core element 7 may abut at the coupling sections 4.3, 4.4.

As shown in FIG. 4, the magnetic flux caused by differential mode currents (I₁, I₂) has the same flow direction in the plate-shaped or bar-shaped core element 7 which improves the differential mode filtering capabilities.

FIG. 5 shows a further embodiment of a choke implementing common mode and differential mode filtering capabilities. The main difference of the embodiment according to FIG. 5 in view of the embodiment of FIG. 2 is that an air gap 8 is provided between the closed magnetic core element 4 and the plate-shaped or bar-shaped core element 7. Said air gap 8 can be provided at one free end of the core element 7, i.e. at one of the coupling sections 4.3, 4.4 or at both free ends of the core element 7 i.e. at the free end arranged close to the coupling section 4.3 and the free end arranged close to the coupling section 4.4.

The filter response of the electromagnetic filtering section 1 can be chosen by the material and the dimensions of the core element 7, respectively, the air gaps 8. The greater the length, width and/or thickness of the core element 7, the greater is the effect of the differential mode filtering effect because the magnetic flux through the core element 7 and therefore the attenuation is increased.

The other way round, one or more air gaps 8 between the closed magnetic core element 4 and the plate-shaped or bar-shaped core element 7 reduce the magnetic flux through the core element 7 and therefore lower the attenuation, respectively, the differential mode filtering effect.

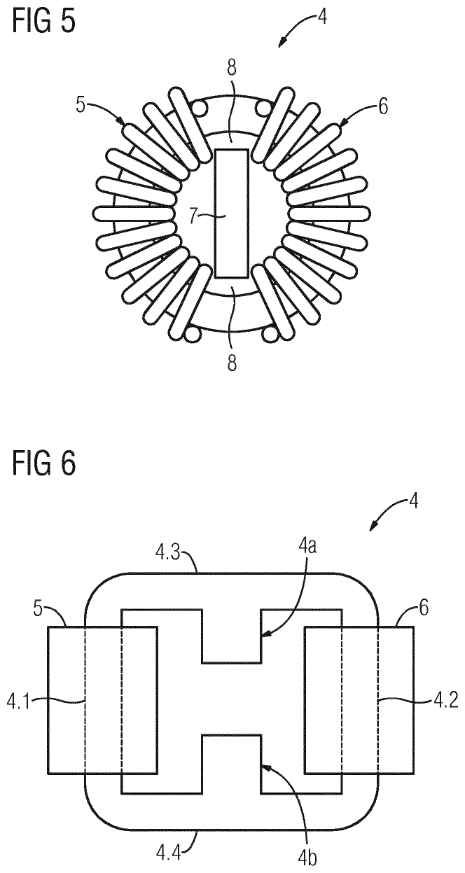

FIG. 6 shows a further embodiment of an electromagnetic filtering section 1. In contrary to the upper-described embodiments, the plate-shaped or bar-shaped core element 7 is eliminated based on a pair of core projections 4a, 4b. A first core projection 4a may be provided at a first coupling section 4.3 and a second core projection 4b may be provided at a second coupling section 4.4. The core projections 4a, 4b may be orientated towards the free centre of the choke and may face each other. So, in other words, the core projections 4a, 4b may reduce the distance between the first and second coupling section 4.3, 4.4 in an area between the coils 5, 6. Preferably, an air gap 8 is provided between the free ends of the core projections 4a, 4b.

As mentioned before, the dimensions of the core projections 4a, 4b (length, width and/or height) and the dimensions of the air gap 8 have influence on the differential mode filtering effect of the choke, respectively, the electromagnetic filtering section 1 and may be dimensioned according to the desired filtering requirements.

The closed magnetic core element 4 and/or the plate-shaped or bar-shaped core element 7 can be manufactured by injection moulding or powder compression moulding. Alternatively or in addition, the closed magnetic core element 4 and/or the plate-shaped or bar-shaped core element 7 can be made of ferrite or laminated metal sheets.

The coils 5, 6 may comprise the same number of turns and the same winding direction (see FIGS. 3 and 4). According to other embodiments, the number of turns of coils 5, 6 may be different in order to enhance the differential filtering effect.

It should be noted that the description and drawings merely illustrate the principles of the proposed invention. Those skilled in the art will be able to implement various arrangements that, is although not explicitly described or shown herein, embody the principles of the invention.

### LIST OF REFERENCE NUMERALS

1 electromagnetic filtering section
1.1 common mode filtering section
1.2 differential mode filtering section
2 AC power input
3 power conversion entity
4 closed magnetic core element
4a, 4b core projections
4.1 coil section
4.2 coil section
4.3 coupling section
4.4 coupling section
5 coil
5.1 coil end
5.2 coil end
6 coil
6.1 coil end
6.2 coil end
7 plate-shaped/bar-shaped core element
8 air gap

1. Induction hob comprising an AC power input and a power conversion entity adapted to provide high frequency electric current to an induction coil, wherein an electromagnetic filtering section is provided between said AC power input and said power conversion entity.

2. Induction hob according to claim 1, wherein said electromagnetic filtering section comprises common mode filtering means and differential mode filtering means.

3. Induction hob according to claim 16, wherein said common mode filtering means is provided in form of said closed magnetic core element and said at least two coils.

4. Induction hob according to claim 16, wherein said differential mode filtering means are adapted to enable a direct magnetic flux between coil ends of each of said at least two coils in order to obtain a differential mode filtering effect.

5. Induction hob according to claim 16, wherein said closed magnetic core element comprises a ring-like or polygonal shape.

6. Induction hob according to claim 16, wherein said differential mode filtering means comprise a bar-shaped or plate-shaped core element arranged between said at least two coils.

7. Induction hob according to claim 6, wherein an air gap is provided at one side or each side between said bar-shaped or plate-shaped core element and said closed magnetic core element.

8. Induction hob according to claim 16, wherein said closed magnetic core element comprises core projections facing each other at opposite sections of the closed magnetic core element, said core projections forming said means for closing a magnetic flux between said coils.

9. Induction hob according to claim 8, wherein the sections of the closed magnetic core element arranged between said at least two coils comprise an E-like or essentially E-like shape.

10. Induction hob according to claim 6, wherein said closed magnetic core element and/or said bar-shaped or plate-shaped core element are injection moulded or powder compression moulded elements.

11. Induction hob according to claim 6, wherein said closed magnetic core element and/or said bar-shaped or plate-shaped core element are made of ferrite or laminated metal sheet.

12. Induction hob according to claim 16, wherein said at least two coils comprise the same number of turns or a different number of turns.

13. Induction hob according to claim 16, wherein said at least two coils comprise the same winding direction.

14. Induction hob according to claim 6, wherein the permeability of said closed magnetic core element and/or said bar-shaped or plate-shaped core element is chosen in order to obtain a desired filtering capability for induction hob applications.

15. Method for increasing differential filtering effect in an induction hob, said induction hob comprising an AC power input and a power conversion entity adapted to provide high frequency electric current to an induction coil, said induction hob further comprising an electromagnetic filtering section provided between said AC power input and said power conversion entity, said electromagnetic filtering section comprising common mode filtering means and differential mode filtering means, wherein said electromagnetic filtering section comprises a closed magnetic core element around which at least two coils are provided, said closed magnetic core element and said coils providing said common mode filtering, and wherein said differential mode filtering means enable a direct magnetic flux between coil ends of each of said at least two coils in order to obtain differential mode filtering effect.

16. Induction hob according to claim 2, said electromagnetic filtering section further comprising a closed magnetic core element around which at least two coils are provided.

17. An induction-coil power unit comprising an AC power input, a power conversion entity adapted to supply high-frequency power to an induction coil, and an electromagnetic filter therebetween, said electromagnetic filter being manufactured as a single electronic component and comprising:
a common mode filtering choke adapted to suppress electric noise signals flowing in the same direction, said common mode filtering choke comprising:
a closed magnetic core element, and
first and second coils wound over opposing portions of said closed magnetic core element,
said closed magnetic core element having first and second coupling sections located opposite to one another and disposed respectively between adjacent free ends of the first and second induction coils would over the closed magnetic core element; and
a differential mode filtering choke adapted to suppress electric noise signals flowing in opposite directions, said differential mode filtering choke comprising one of the following:
a plate- or bar-shaped core element arranged to provide a magnetic flux between the opposite coupling sections of the closed magnetic core element, a first end of the plate- or bar-shaped core element disposed adjacent to said first coupling section, and a second end of the plate- or bar-shaped core element disposed adjacent to said second coupling section, or
first and second core projections extending toward one another respectively from the first and second coupling sections of the closed magnetic core element and arranged to provide a magnetic flux between said first and second coupling sections, inward-directed terminal ends of said first and second core projections being spaced from one another by a central gap therebetween.

18. The induction-coil power unit according to claim 17, the first end of said plate- or bar-shaped core element being spaced from said first coupling section of the closed magnetic core element by a first gap, the first gap being preselected to yield a predetermined differential filtering effect by introducing a predetermined degree of differential electric noise signal attention.

19. The induction-coil power unit according to claim 17, the first end of said plate- or bar-shaped core element abutting the first coupling section of the closed magnetic core element.

20. The induction-coil power unit according to claim 17, said closed magnetic core element of the common mode filtering choke being formed together as a single piece with either: said plate- or bar-shaped core element, or said first and second core projections.
